(19) United States
(12) Patent Application Publication
(10) Pub. No.: US 2013/0172148 A1
(43) Pub. Date: Jul. 4, 2013

(54) METHOD FOR OPERATING A DRIVETRAIN

(71) Applicants: Norbert Wiencek, Hagnau (DE); Bernd Doebele, Salem (DE)

(72) Inventors: Norbert Wiencek, Hagnau (DE); Bernd Doebele, Salem (DE)

(73) Assignee: ZF FRIEDRICHSHAFEN AG, Friedrichshafen (DE)

(21) Appl. No.: 13/821,387

(22) PCT Filed: Aug. 3, 2011
(86) PCT No.: PCT/EP2011/063331

§ 371 Date: Mar. 7, 2013

(30) Foreign Application Priority Data
Sep. 9, 2010 (DE) 10 2010 040 455.1

(51) Int. Cl. B60W 10/11; B60W 10/04; B60W 10/02

(52) U.S. Cl. CPC B60W 10/11; B60W 10/02; B60W 10/04
USPC 477/77

(57) ABSTRACT

A method for operating a drive train having a variable speed transmission connecting a drive unit with an output drive. The transmission has gears that can be selected by the driver and has a clutch that can be manually actuated. The torque intended by the driver is determined based on accelerator pedal actuation and the drive unit is operated on that basis. Whenever the driver disengages the clutch and changes gears, the torque intended by the driver is not used for operating the drive unit, rather the drive unit is automatically operated by a rotational speed control. In a first phase rotational speed control, a target value is automatically determined, that is independent of the current transmission input speed, and used for the rotational speed control. During a second phase, a target value which is dependent on the current transmission input speed is used for the rotational speed control.

This application is a National Stage completion of PCT/EP2011/063331 filed Aug. 3, 2011, which claims priority from German patent application serial no. 10 2010 040 455.1 filed Sep. 9, 2010.

### FIELD OF THE INVENTION

The invention relates to a method for operating a drive.

### BACKGROUND OF THE INVENTION

A method for operating a drive train by means of a drive unit and having a manual transmission connecting the drive unit and an output drive is known from document DE 10 2008 042 385 A1. A manual transmission refers to a multi-step variable speed transmission, the transmission comprising a plurality of gears that can be selected by the driver. According to the method disclosed therein, it is suggested that a gear brake that is or that can be brought into an operative connection with a transmission input shaft be used for assisted shifting, in order to automatically reduce a speed difference occurring on a gear clutch of the target gear as a result of shifting. With this method according to DE 10 2008 042 385 A1, assisted shifting can already be provided to some extent for a drive train having a manual transmission.

Although methods are already known from the prior art, by means of which assisted shifting can be guaranteed on a drive train having a manual transmission, there is a need for novel methods of operating a drive train, by means of which assisted shifting on a drive train having a manual transmission can be further improved.

### SUMMARY OF THE INVENTION

On this basis, the present invention's objective is based on creating a novel method for operating a drive train. This objective is achieved by a method according to the invention in which, whenever the clutch is disengaged by the driver and when furthermore a gear change is carried out by the driver, the torque intended by the driver is not used to operate the drive unit.

Rather, according to the invention, the drive unit is automatically operated by a rotational speed control when the drive train is operated in this situation, of the drive train, wherein a target value for the rotational speed control is determined automatically such that a target value independent of the current transmission input speed is used in a first phase of the rotational speed control, and a target value dependent on the current transmission input speed is used in a second phase of the rotational speed control of the drive unit.

According to the invention, it is therefore suggested that whenever a clutch drive is disengaged as a result of driver actuation, and when a gear change is carried out by the driver, the drive unit be automatically operated by a rotational speed control, wherein the rotational speed control is subdivided into two phases, namely into a first phase, in which a target value for the rotational speed control is determined independently of the current transmission input speed, and in a second phase, in which the target value for the rotational speed control is determined dependent upon the current transmission input speed. This makes it possible to adapt the rotational speed of the drive unit to a transmission input speed in a particularly preferred manner, in order to guarantee the lowest possible speed difference between the rotational speed of the drive unit and the transmission input speed the next time the clutch is engaged after carrying out a gear change, and therefore to minimize wear on the clutch.

According to an advantageous embodiment of the invention, a target value for the rotational speed control is automatically used during the second phase of the rotational speed control, the target value being dependent on an output rotational speed of the transmission and a gear ratio of the gear engaged before the gear change, wherein a target value for the rotational speed control is automatically used during the second phase of the rotational speed control, which corresponds to the filtered, current transmission input speed.

At the latest, in a synchronizing phase of the transmission, a target value for the rotational speed control is automatically used, which corresponds to the filtered, current transmission input speed.

### BRIEF DESCRIPTION OF THE DRAWINGS

Preferred developments of the invention can be derived from the description that follows. Embodiments of the invention are explained in greater detail with reference to the drawings, without being limited thereto. In the drawings:

FIG. 1 a schematic configuration of a drive train;

FIG. 2 a state graph to illustrate the invention;

FIG. 3 a first timing chart to illustrate the invention for an upshift; and

FIG. 4 a second timing chart to illustrate the invention for a downshift.

### DETAILED DESCRIPTION OF THE PREFERRED EMBODIMENTS

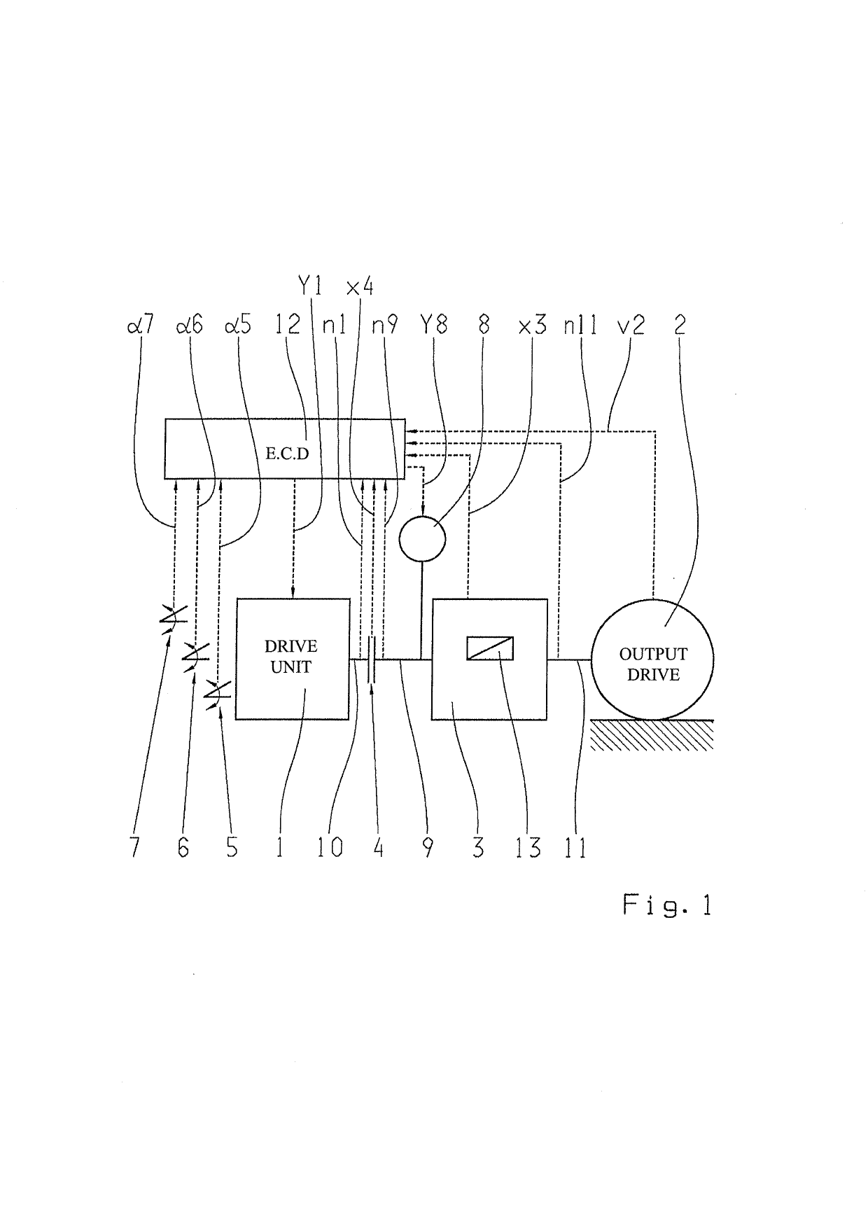

The invention relates to a method for operating a drive train, wherein FIG. 1 shows a highly schematic diagram of an exemplary drive train, wherein the inventive method can be used.

Thus the drive train in FIG. 1 is equipped with a drive unit 1, an output drive 2 and a multi-step variable speed transmission 3 connecting the drive unit 1 and the output drive 2, the transmission comprising a plurality of gears that can be selected by the driver. Such a multi-step variable speed transmission having gears that can be manually engaged is also known as a manual transmission.

In addition, the drive train in FIG. 1 incorporates a clutch 4 that can be manually actuated by the driver, which connects the drive unit 1 and the multi-step variable speed transmission 3.

In addition, FIG. 1 shows a clutch pedal 5 for the manual actuation of the clutch 4, an accelerator pedal 6, which is known as a gas pedal, as well as a brake pedal 7. The clutch pedal 5, accelerator pedal 6 and brake pedal 7 can be actuated by the driver.

In addition, the drive train of FIG. 1 incorporates a gear brake 8, which is associated with the multi-step variable speed transmission 3. The gear brake 8 is or can be coupled with a transmission input shaft 9, wherein the clutch 4 also engages with the transmission input shaft 9, via which the transmission input shaft 9 can be coupled with a drive unit shaft 10. A transmission output shaft 11 is in an operative connection with the output drive 2.

In accordance with the dashed arrows in FIG. 1, the above mentioned components of the drive train exchange control-side data with a control device 12 for operating the drive train. Thus a rotational speed n1 of the drive unit 1, a rotational speed n9 of a transmission input shaft, a rotational speed n11 of a transmission output shaft, a driving speed v2 of the drive train, a clutch pedal position a5, an accelerator pedal position a6, a brake pedal position a7 and a clutch position signal x4 from a provided clutch sensor (not shown) are provided as input data to the control device 12.

The control device 12 can deduce from the clutch position signal x4 and/or the clutch pedal position a5, whether the clutch 4 is completely engaged, completely disengaged, or partially engaged or partially disengaged. Preferably a distinction is made between three operating positions or three operating ranges regarding the position or status of the clutch 4, namely between a completely disengaged clutch 4, a completely engaged clutch 4 and a partially engaged clutch 4.

The control device 12 can derive a torque intended by the driver from the accelerator pedal position a6 and/or brake pedal position a7. Alternatively, a torque intended by the driver may also be provided to the control device 12 from another control device. A torque intended by the driver refers to a torque, on the basis of which the drive unit 1 can be operated in such a way, that the drive unit can provide an actual driving torque that corresponds to the torque intended by the driver, wherein to that end, a fuel quantity supplied to the drive unit 1 is typically determined based on the torque intended by the driver.

A signal x3 of the transmission 3 is provided to the transmission controller 12 as an additional input variable, wherein the signal x3 of the transmission 3 concerns an output variable of a so-called neutral switch 13 of the transmission 3. The signal x3 therefore provides information regarding whether the multi-step variable speed transmission 3 of the manual transmission is in a neutral position or not.

The drive train is operated dependent upon the above mentioned input variables, namely dependent upon an evaluation of one or more of the input variables as described and defined in detail below, wherein the control device 12 according to FIG. 1 provides two output variables, Y1 and Y8, namely an output variable Y1 for operating the drive unit 1 and an output variable Y8 for operating the gear brake 8.

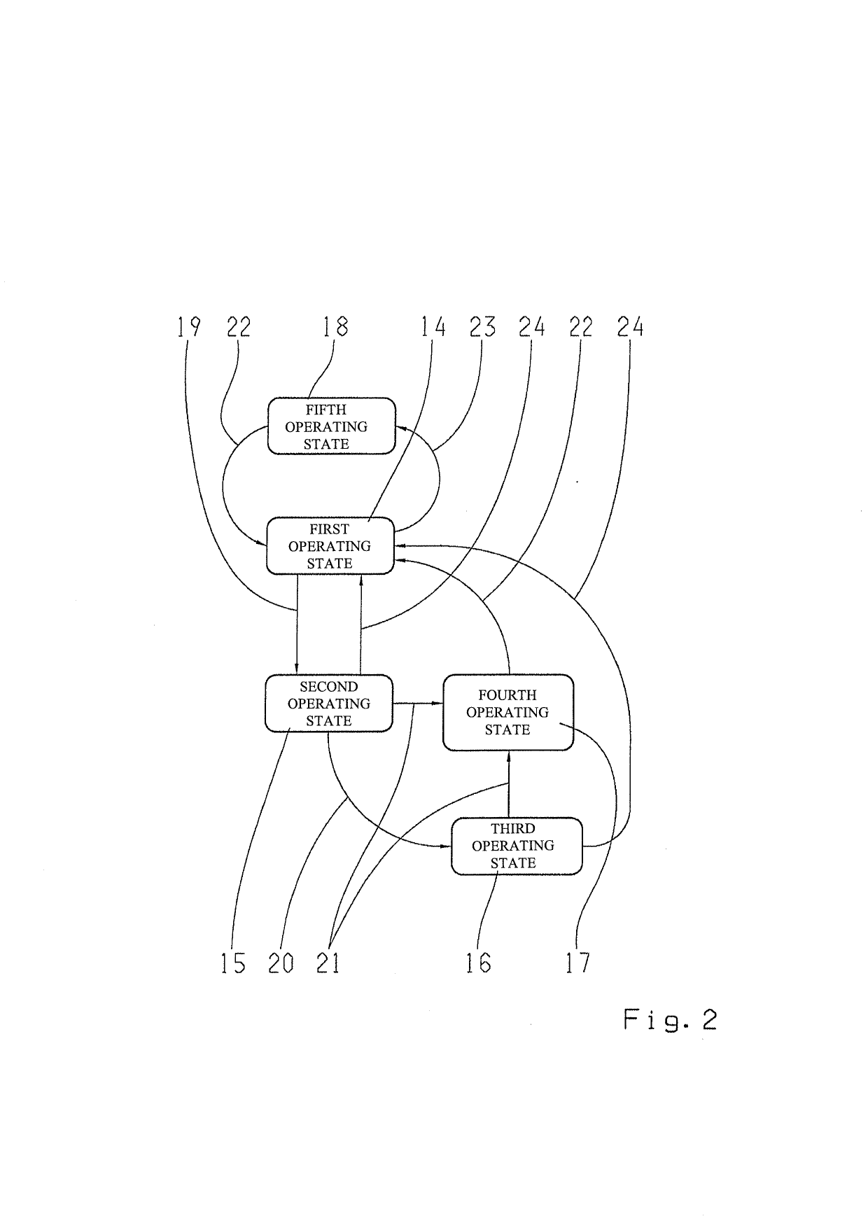

In the following it can be assumed that when operating the drive train shown in FIG. 1, a distinction is made between the five operating states 14, 15, 16, 17 and 18 shown in the state graph in FIG. 2, wherein no shifting occurs in the multi-step variable speed transmission 3 in the first operating state 14, and accordingly no shift is carried out, and the clutch 4 is also completely engaged in the first operating state 14.

Likewise, no shifting occurs and the clutch 4 is engaged in the multi-step variable speed transmission 3 in the fifth operating state 18. The operating states 14 and 18 differ, however, in terms of an engine control intervention provided by the control device 12, the engine control intervention provided by the engine control device 12 is not active in the first operating state 14, whereas in the fifth operating state 18, the engine control intervention provided by the engine control device 12 is active.

For the engine control intervention of the control device 12, it should be understood that in the case of non-active engine control intervention, the drive unit 1 is operated on the basis of the above mentioned torque intended by the driver. In the case of an active engine control intervention, on the other hand, the drive unit 1 is not operated on the basis of the above mentioned torque intended by the driver, but rather, is operated as described in detail below.

A shifting is carried out in the multi-step variable speed transmission 3 in each of the operating states 15, 16 and 17, accordingly a shifting in the multi-step variable speed transmission 3 is active in these three operating states 15, 16 and 17, wherein the clutch 4 is disengaged or partially disengaged/engaged and the engine control intervention provided by the control device 12 is not active in the second operating state 15, wherein the clutch 4 is completely disengaged and the engine control intervention provided by the control device 12 is active in the third operating state 16, and wherein the clutch 4 is disengaged or partially disengaged/engaged and the engine control intervention provided by the control device 12 is active in the fourth operating state 17.

When carrying out a shifting in the multi-step variable speed transmission 3, the operating states 14, 15, 16, 17 and 14 are typically run though in succession.

In addition, it is possible that the operating states 14, 15, 17 and 14 will be run through in succession, namely when the clutch 4 is only tapped and released by the driver.

It is also possible that the operating states 14, 18 and 14 will be run through, namely in particular in the case of a push/pull change in the drive train outside of gear changes and shifts.

Moreover the operating states 14, 15, 14 or 14, 15, 16, 14 can also be run through, namely when signals are absent in the operating states 15 and/or 16.

The transition between the operating states 14 to 18 is defined in accordance with FIG. 2 via so-called transition conditions 19, 20, 21, 22, 23 and 24. Thus a transition from the first operating state 14 into the second operating state 15 is possible when the transition condition 19 has been met. A transition can be made from the second operating state 15 into the third operating state 16 when the transition condition 20 is met. Then when the transition condition 21 has been met, a transition can be made either from the second operating state 15 into the fourth operating state 17 or from the third operating state 16 into the fourth operating state 17. Then when the transition condition 22 has been met, a transition can be made from the fourth operating state 17 into the first operating state 14 or from the fifth operating state 18 into the first operating state 14. The transition condition 23 defines the transition from the first operating state 14 into the fifth operating state 18, whereas the transition condition 24 defines the transition from the third operating state 16 into the first operating state 14.

The individual operating states 14 to 18 and the transition conditions 19 to 24 will be discussed in detail below.

As has been stated previously, no shifting occurs in the first operating state 14 in the multi-step variable speed transmission 3, and furthermore the clutch 4 is completely engaged. A first operating state 14 refers to a rest state between two shiftings. In the first operating state 14, the above mentioned engine control intervention of the control device 12 is not active, but rather in the first operating state 14, the drive unit 1 is operated dependent upon a torque intended by the driver, which is either determined by the control device 12 or provided by another control device. As has been stated previously, the torque intended by the driver depends on the accelerator pedal position a6. In the first operating state 14, the output variable Y1, on the basis of which the drive unit 1 is operated, corresponds to the torque intended by the driver. In the first operating state 14, the gear brake 8 is disengaged via the output variable Y8. In addition, in the first operating state 14, the current gear ratio is calculated from a ratio of the transmission input speed n9 and the output rotational speed of the transmission n11, wherein an actual gear currently engaged in the multi-step variable speed transmission 3 can be determined or calculated dependent upon this gear ratio. The gear ratio and the actual gear can be stored in the control device 12.

In the second operating state 15, in which a shifting occurs in the multi-step variable speed transmission 3, the clutch 4 is disengaged such that the clutch 4 is therefore partially disengaged or partially engaged in the second operating state 15. In the second operating state 15 there is no intervention of the control device 12 in the engine torque, but rather the drive unit 1 is also operated dependent upon the torque intended by the driver in the second operating state 15. The driver therefore also influences a reduction of the torque of the drive unit 1 in the second operating state 15 by actuating his accelerator pedal a6 himself. The output signal Y1 issued by the control device 12 therefore also corresponds to the torque intended by the driver in the second operating state 15. Furthermore the gear brake 8 is deactivated via the output variable Y8 in the second operating state 15.

The clutch 4 is completely disengaged in the third operating state 16, in which a shifting is likewise active in the multi-step variable speed transmission 3. According to the invention, it is suggested that the torque intended by the driver not be used to operate the drive unit 1 when the clutch 4 is completely disengaged by the driver and further, when the driver carries out a gear shifting in the multi-step variable speed transmission 3, thus when the third operating state 16 is present, but rather, the drive unit 1 is operated independently of an intervention by the control device 12, namely in such a way that the drive unit is automatically operated by a rotational speed control in the third operating state 16.

This rotational speed control, which is specified by the control device 12, occurs automatically, in such a way that in a first phase of the rotational speed control, a target value that is independent of the current transmission input speed n9 is used for the rotational speed control, wherein, in a phase of the rotational speed control that is subsequent to the first phase, a target value that is dependent on the current transmission input speed is used for the rotational speed control of the drive unit 1.

The target value that is used during the second phase of the rotational speed control in the third operating state 16 is preferably dependent on an output rotational speed of the transmission n11, as well as being dependent on a ratio of the transmission 3 of the gear engaged in the transmission 3 before the gear change. The relevant transmission output speed n11 before carrying out a gear change is multiplied by the relevant gear ratio of the last gear engaged before the gear change, in order to provide the target value for the first phase of the rotational speed control in the third operating state 16 in this way. The ratio needed for this was calculated in the first operating state 14.

According to an advantageous embodiment of the invention, the target rotational speed for the rotational speed control of the vehicle speed v2 is tracked during the first phase of the rotational speed control in the third operating state 16.

In addition, the current transmission input rotational speed 9 is preferably filtered during the second phase of the rotational speed control, and a theoretical target value for the rotational speed control is calculated from the filtered, current transmission input speed n9 of the transmission 3, although, however, this is not used for rotational speed control during the first phase. Rather, the rotational speed control is done during the first phase on the basis of the target value, which is dependent on the relevant transmission output speed before the gear change as well as on the gear that is engaged before the gear change.

At the end of the first phase of the rotational speed control, which is preferably defined by a constant, applicable period of time, the filtered, current transmission input speed n9 is used as a target rotational speed for the rotational speed control during the subsequent second phase of the rotational speed control, wherein the filter effect for the filtering of the transmission input speed n9 is attenuated when forming the target value for the speed rotational speed control with increasing time. The current, unfiltered transmission input speed is used as a target rotational speed for the rotational speed control at the latest during and after a synchronization phase of the transmission 3.

The foregoing rotational speed control, namely the duration of the second phase of the rotational speed control or the total duration of the first phase and the second phase of the rotational speed control, is limited by an applicable, maximum time period, at the end of which the rotational speed control is automatically terminated. After this maximum time period has been exceeded, the foregoing rotational speed control is no longer allowed until the next shifting.

The foregoing rotational speed control is also terminated immediately when the clutch 4 is no longer fully disengaged. Thus, if the clutch 4 is engaged by the driver, the foregoing rotational speed control is automatically terminated, which means both from the first phase of the rotational speed control and from the second phase of the rotational speed control.

The filtering of the current transmission input speed n9 in order to determine the target values for the rotational speed control during the second phase of the same can be obtained using a sliding mean-value formation. The filtering effect of this filtering decreases as the time of the rotational speed control increases.

For the rotational speed control, the corresponding target value for the rotational speed control is compared with a measured actual value of the rotational speed n1 of the drive unit 1, wherein, dependent upon a control deviation, a controller generates a manipulated variable so that the actual rotational speed is brought closer to or follows the target rotational speed. This can be obtained using a PID controller. Alternatively, this can also be obtained based on the characteristic map. The manipulated variable of the controller, which outputs the same in order to bring the actual rotational speed closer to the target rotational speed, typically relates to the target rotational speed for the drive unit 1. The target rotational speed hereby determined by the controller can be corrected with an offset value to compensate for frictional losses of the drive unit 1.

The breakdown of the foregoing rotational speed control in the first phase and the second phase has the advantage that, at the start of the first phase, in which the current transmission input speed may still be subject to string oscillations, a target value for the rotational speed control that is independent of the current transmission input speed can be used. Only during the second phase is a target value for the rotational speed control used that is dependent on the current transmission input speed, wherein any oscillations of the transmission input speed can be filtered if necessary.

Then, when the rotational speed control in the third operating state 16 is terminated and the third operating state 16 is still active, or when a transition is made to the fourth operating state 17 by engaging the clutch, an intervention is made via the control device 12, namely in such a way that the drive unit 1 is operated dependent upon a torque target value, which is essentially decoupled from the torque intended by the driver, which, however, is limited by the torque intended by the driver.

Accordingly, the control device 12 does not specify a target value for the rotational speed for operating the drive unit in the fourth operating state 17 and in the third operating state 16, when the rotational speed control has been terminated but rather, specifies a torque target value, which is essentially decoupled from the torque intended by the driver, however which is limited by the torque intended by the driver. The last valid target value for the engine speed in the third operating state 16 based on the rotational speed control serves as a starting value for this torque target value, wherein when the torque target value is less than the torque intended by the driver, the torque target value is increased to the torque intended by the driver starting from the last valid target value for the engine speed in the rotational speed control. The increase in the torque target value to the torque intended by the driver dependent upon the actuation of the accelerator pedal can be obtained continuously or in several steps.

Then, when the clutch 4 is partially engaged and the torque target value corresponds to the torque intended by the driver, the engine control intervention is not deactivated by the control device 12. However, when the clutch 4 is completely engaged, and the torque intended by the driver and the torque target value are equivalent, the engine control intervention is deactivated by the control device 12 and the drive unit 1 is subsequently operated based on the torque intended by the driver.

As has been stated previously, the fifth operating state 18 is an operating state not occurring during a shifting, therefore in which no shifting occurs in the transmission 3 and furthermore, in which the clutch 4 is completely engaged.

The fifth operating state 18 preferably corresponds to a push/pull change in the drive train, wherein in a push/pull change in the drive train, the drive unit 1 is operated via an engine control intervention by the control device 12 dependent on a torque target value, such that the torque target value is adjusted with a delay to the torque intended by the driver dependent on the actuation of the accelerator pedal.

This engine control intervention for the push/pull change preferably only occurs when the driver moves the accelerator pedal 6 from a thrust position, which is defined, for example, by an accelerator pedal actuation a6 of less than 3%. With an accelerator pedal setting a6 below this thrust position, the torque target value is set approximately to zero, however it is not yet used in the operation of the drive unit 1. Only when the accelerator pedal has been moved from the thrust position, when the accelerator pedal angle a6 is greater than or equal to 3%, for example, is a torque target value specified, which is adjusted slowly to the torque intended by the driver. Here, the torque intended by the driver serves as a maximum value, with the result that when the torque intended by the driver is smaller than the torque target value, the torque intended by the driver is used for operating the drive unit 1, and that when the torque intended by the driver is greater than the torque target value, the torque target value is slowly brought closer to the torque intended by the driver. Then, when the torque target value reaches the torque intended by the driver, the fifth operating state 18 is abandoned, a change is made into the first operating state 14 and this engine control intervention, which is permitted only once per push/pull change, is terminated.

The transition condition 19 for switching from the first operating state 14 to the second operating state 15 is met when the coupling status of the clutch 4 changes from a completely engaged to a partially engaged coupling, when the input signals of the control device 12 are valid, when a vehicle speed v2 is greater than a specified limiting value, and when an ignition of the vehicle is activated.

The transition condition 20 for switching from the second operating state 15 to the third operating state 16 is met when the coupling status has changed from a partially engaged to a completely disengaged state, moreover when the input signals of the control device 12 are valid, furthermore when the vehicle speed is greater than aforementioned limiting value, when the ignition is activated.

The transition condition 21 for switching from the third operating state 16 to the fourth operating state 17, or for switching from the second operating state 15 to the fourth operating state 17 is met when the clutch 4 is engaged and the coupling status is then partially engaged, moreover when the input signals of the control device 12 are valid, when the vehicle speed is greater than the aforementioned limiting value, and when the ignition of the vehicle is activated.

A change from the fourth operating state 17 into the first operating state 14 as well as a change from the fifth operating state 18 into the first operating state 14 in the sense of the transition condition 22 occurs when the clutch 4 is completely engaged and moreover when a torque target value for operating the drive unit 1 is greater or equal to the torque intended by the driver. Alternatively, the transition condition 22 is met when one or more of the input signals of the control device 12 are below par, or when the ignition of the vehicle is activated, or when the vehicle speed is less than a limiting value.

The transition condition 23 for switching from the first operating state 14 to the fifth operating state 18 is met when the clutch 4 is engaged, moreover when the accelerator pedal is transferred from the thrust position into a pull position, and furthermore when input signals of the control device 12 are valid, the vehicle speed is greater than a limiting value and the ignition of the vehicle is activated.

A change from the second operating state 15 to the first operating state 14 in the sense of the transition condition 24 occurs when either at least one input signal of the control device 12 is invalid, or when the vehicle speed falls below a limiting value, or when the ignition of the vehicle is deactivated.

According to an advantageous embodiment of the method according to the invention, when the clutch 4 is fully disengaged and when carrying out a shifting, or in other words when the third operating state 16 is present and moreover when the neutral switch 13 for the transmission 3 according to the signal x3 indicates that the transmission 3 is in a neutral setting, the gear brake 8 can be automatically deactivated via the output signal Y8 of the control device 12, namely when a difference between an engine speed n1 of the drive unit and a preferably filtered transmission input speed n9 is greater than an applicable, first upper limiting value. Then, when this difference between the engine speed n1 and the transmission input speed n9 subsequently reaches or falls below a second lower limiting value, the gear brake 8 is then automatically deactivated, again via the output signal Y8. In addition, the gear brake 8 is then deactivated when a transition condition from the third operating state 16 is met in another operating state, or in other words when the third operating state 16 is no longer valid.

In addition, the gear brake 8 is automatically deactivated when the clutch 4 is no longer completely disengaged and/or when the neutral switch 13 signals to the transmission 3 that the transmission 3 is no longer in neutral.

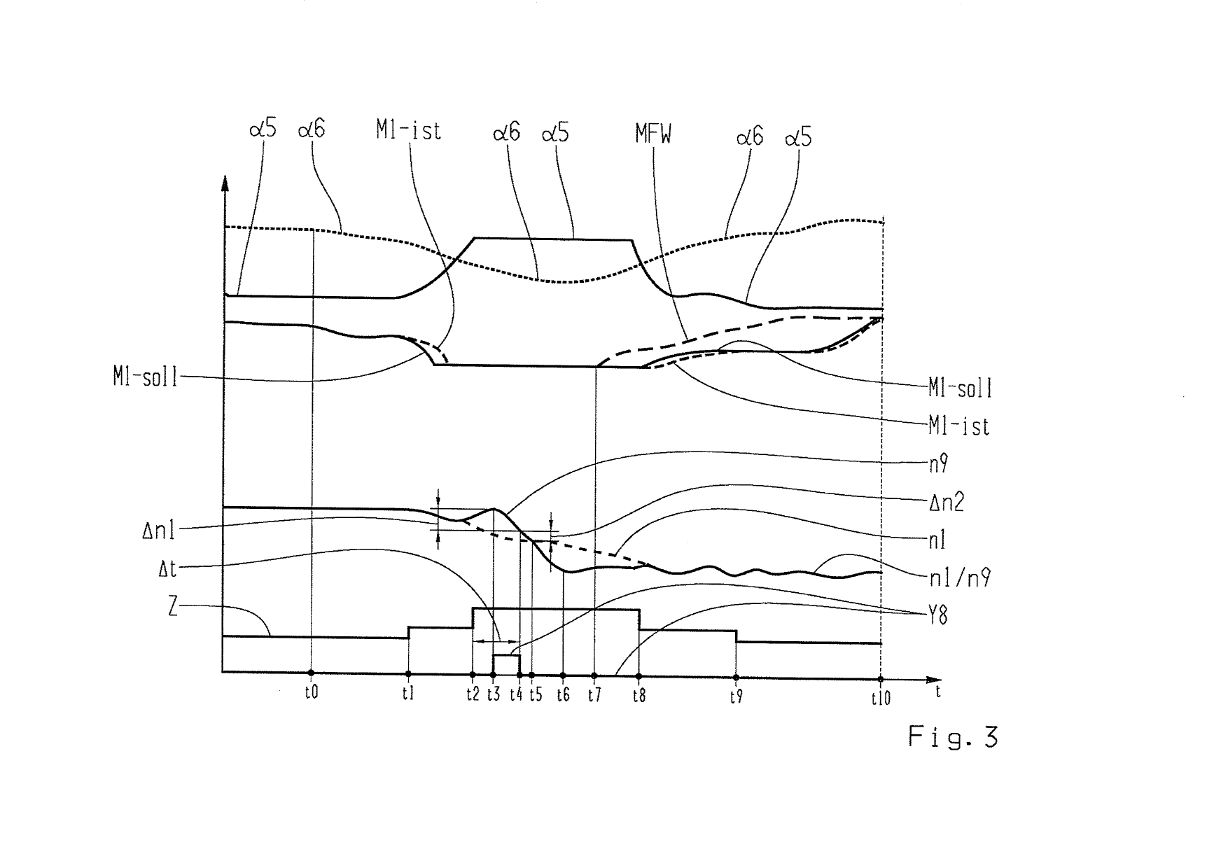

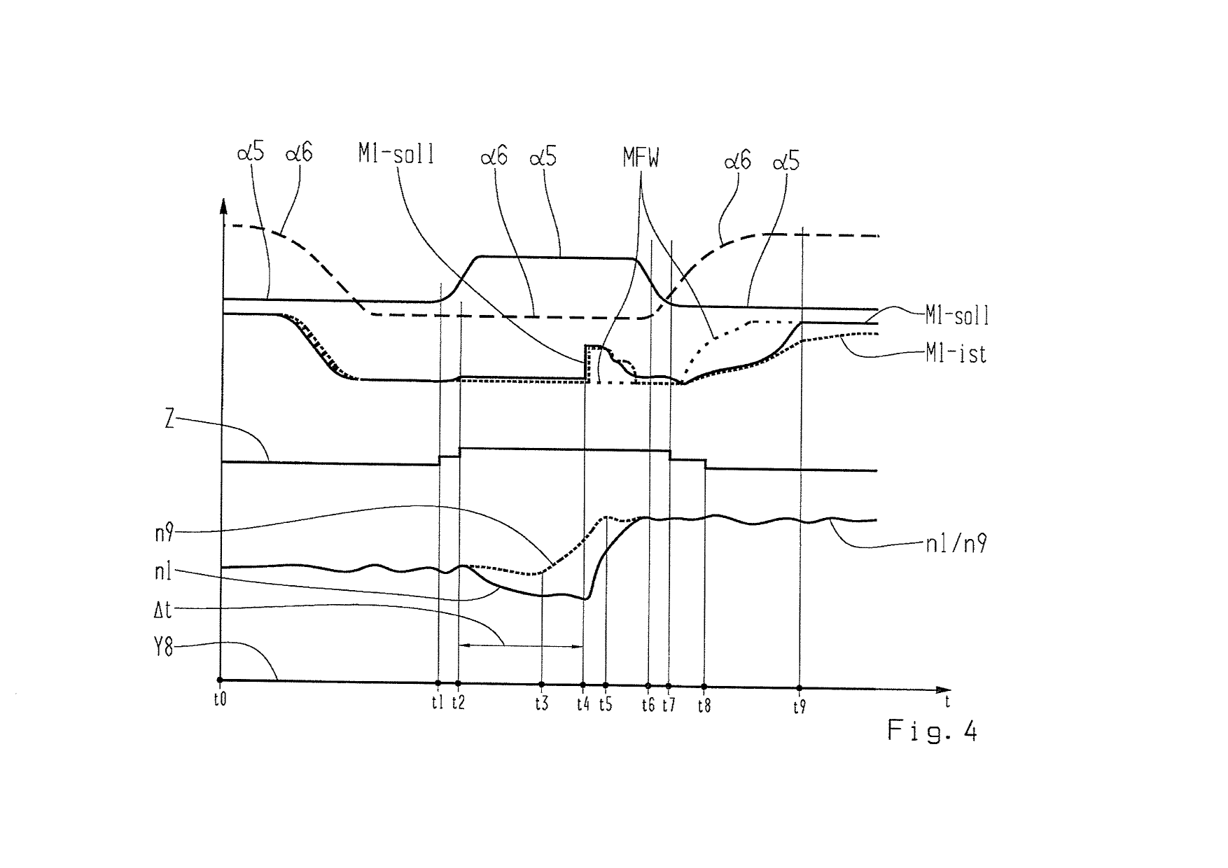

FIGS. 3 and 4 show a plurality of temporal signal courses over the period of time t, which may be formed when using the method according to the invention, namely in FIG. 3 for an upshift and in FIG. 4 for a downshift, wherein in FIGS. 3 and 4 each show an actuation of an accelerator pedal a6, a clutch pedal actuation a5, an engine speed n1, a transmission input speed n9, a torque intended by the driver MFW, dependent on the actuation of the accelerator pedal, an actual rotational speed M1-IST of the drive unit 1, a torque target value M1-SOLL for the drive unit 1, an actuation signal Y8 for the gear brake 8, as well as a signal Z are plotted over a period of time t. The signal Z provides information regarding the status of the clutch 4, or, in other words, information about whether the clutch 4 is completely engaged, completely disengaged, or partially engaged or partially disengaged.

In the case of the upshift in FIG. 3, the driver retracts the actuation of the accelerator pedal a6 at time t0, wherein at time t1, the clutch is actuated and the coupling status is changed from completely engaged to partially engaged. At time t2, the clutch 4 is completely disengaged, wherein the third operating state 16 is then present, in which a rotational speed control initially occurs. The first phase of the rotational speed control, in which a target value for the rotational speed control that is independent of the transmission input speed n9 is used, extends between the times t2 and t4, and the first phase of the rotational speed control is therefore labeled t. In FIG. 3 it can further be seen that at time t3, the gear brake 8 is activated via the signal Y8 until time t4, in order to decelerate the transmission input speed n9.

At time t5 the synchronization in the transmission begins and a shift is made to the new gear, wherein at time t6, the synchronization is completed and the gear is engaged. At time t7, the driver starts to accelerate again by actuating the accelerator pedal 6, wherein at time t8, the second phase of the rotational speed control ends. Subsequently at time t8, a rotational speed control is therefore no longer performed for operating the drive unit 1, but rather a torque target value M1-SOLL is specified, which is basically decoupled from the torque intended by the driver MFW, limited, however, to a maximum by the torque intended by the driver MFW. The actual engine torque M1-IST follows the torque target value M1-SOLL. At time t9, the clutch changes from partially engaged to completely engaged. At time t10, the torque intended by the driver MFW and the torque target value M1-SOLL are equal, so that the engine control intervention is completed and the operation of the drive unit 1 is carried out based on the torque intended by the driver MFW. In FIG. 3, the limiting values for the speed difference between the transmission input speed n9 and the engine speed n1, at which the gear brake 8 is activated or deactivated respectively, are represented by n1 or n2 respectively.

In the case of the downshift in FIG. 4, the driver begins to retract the accelerator pedal position a6 likewise at time t0, and therefore with an accelerator release, wherein at time t1, the coupling status is changed from completely engaged to the status of partially engaged. At time t2, the status is changed from partially engaged to completely disengaged, wherein the first phase of the rotational speed control occurs starting at time t2, until time t4. At time t4, a changeover is made to the second phase of the rotational speed control, wherein the synchronization process first begins at time t3 and a gear is engaged in the transmission. At time t5, the synchronization process in the transmission is completed and a new gear is engaged in the transmission 3.

At time t6, the driver starts to accelerate again by actuating the accelerator pedal 6, wherein at time t7, the second phase of the rotational speed control ends and a torque target value M1-SOLL for operating the drive unit is specified, which is essentially decoupled from the torque intended by the driver MFW, which, however, is limited by the same. At time t8, the coupling status changes from partially engaged to completely engaged. At time t9 the torque intended by the driver MFW and the target torque M1-SOLL are equal, so that the engine control intervention is again completed and the operation of the drive unit 1 is based on the torque intended by the driver.

### REFERENCE CHARACTERS

1 drive unit

2 output drive

3 multi-step variable speed transmission/manual transmission

4 clutch

5 clutch pedal

6 accelerator pedal

7 brake pedal

8 gear brake

9 transmission input shaft

10 drive unit shaft

11 transmission output shaft

12 control device

13 neutral switch

14 operating state

15 operating state

16 operating state

17 operating state

18 operating state

19 transition condition

20 transition condition

21 transition condition

22 transition condition

23 transition condition

24 transition condition

1-14. (canceled)

15. A method of operating a drive train by a drive unit in which a multi-step variable speed transmission connects the drive unit with an output drive, the transmission comprising a plurality of gears that are selectable by a driver and having a clutch that is manually actuatable by the driver and connected between the drive unit and the multi-step variable speed transmission, the method comprising the steps of:
determining a torque intended by the driver as a function of an actuation of an accelerator pedal of the drive train by the driver;
operating the drive unit based on the torque intended by the driver;
when the clutch is disengaged by the driver and a gear change is carried out by the driver, terminating using the torque intended by the driver for operating the drive unit and automatically operating the drive unit by a rotational speed control;
during a first phase of the rotational speed control, automatically determining and utilizing a target value for the rotational speed control with the target value being independent of current transmission input speed; and
during a second phase of the rotational speed control, utilizing another target value which is dependent on the current transmission input speed.

16. The method according to claim 15, further comprising the step of automatically utilizing, during the second phase of the rotational speed control, a target value for the rotational speed control, which is dependent on an output rotational speed of the transmission and a gear ratio of a gear engaged before the gear change.

17. The method according to claim 15, further comprising the step of automatically utilizing, during the second phase of the rotational speed control, a target value for the rotational speed control which corresponds to a filtered transmission input speed.

18. The method according to claim 17, further comprising the step of automatically attenuating a filtering effect of the filtering of the transmission input speed with increasing time.

19. The method according to claim 17, further comprising the step of automatically utilizing at the latest, during a synchronization phase of the transmission, a target value for the rotational speed control which corresponds to the transmission input speed.

20. The method according to claim 15, further comprising the step of determining a duration of the first phase of the rotational speed control over a constant, applicable period of time.

21. The method according to claim 15, further comprising the step of limiting either a duration of the first phase of the rotational speed control or a total duration of the first phase and the second phase of the rotational speed control by a maximum period of time.

22. The method according to claim 15, further comprising the step of automatically terminating the rotational speed control when the clutch is engaged by the driver.

23. The method according to claim 22, further comprising the step of operating the drive unit, subsequent to the rotational speed control, dependent upon a torque target value which is decoupled from the torque intended by the driver, and the torque intended by the driver limits the torque target value.

24. The method according to claim 23, further comprising the step of raising the torque target value, when the torque intended by the driver is greater than the torque target value, starting from a last valid engine torque in the rotational speed control to the torque intended by the driver.

25. The method according to claim 22, further comprising the step of maintaining the decoupling of the torque target value from the torque intended by the driver when the clutch is partially engaged.

26. The method according to claim 22, further comprising the step of completing the decoupling of the torque target value from the torque intended by the driver when the clutch is completely engaged.

27. The method according to claim 15, further comprising the step of automatically activating a gear brake in order to reduce the transmission input speed, when the clutch is completely disengaged and when a transmission is in neutral and when a difference between the engine torque and the transmission input speed is greater than a first, upper limit value; and
automatically deactivating the gear brake, when a difference between the engine torque and the transmission input speed, either reaches or falls below a second, lower limit value.

28. The method according to claim 15, further comprising the step of operating the drive unit independent of a torque target value such that the torque target value is slowly adjusted to the torque intended by the driver, when the clutch is completely engaged, not during a gear change, in a push/pull change in the drive train.
